(19) United States
(12) Patent Application Publication
(10) Pub. No.: US 2016/0068410 A1
(43) Pub. Date: Mar. 10, 2016

(54) CLEANING WATER USING CHITOSAN

(71) Applicants: Soheil Bahrebar, Tehran (IR); Ali Mehdi Nia, Tehran (IR)

(72) Inventors: Soheil Bahrebar, Tehran (IR); Ali Mehdi Nia, Tehran (IR)

(21) Appl. No.: 14/944,401

(22) Filed: Nov. 18, 2015

(30) Foreign Application Priority Data
Nov. 23, 2014 (IR) 13935014000300922

(51) Int. Cl. C02F 1/28; A01K 63/04

(52) U.S. Cl. CPC C02F 1/286; A01K 63/04; C02F 2101/163

(57) ABSTRACT

A method for cleaning water is disclosed. The method includes adding chitosan into an solution of acetic acid; adding thiosemicarbazide into the solution having the added chitosan; and stirring the solution having the added chitosan and thiosemicarbazide. The stirred solution is then neutralized with aqueous sodium hydroxide to form precipitates. The precipitates are then filtered and washed a plurality of times with deionized water and ethanol. The washed precipitates are then dried under vacuum to produce a modified chitosan. The modified chitosan is added to the water to remove chemicals from the water.

### CROSS REFERENCE TO RELATED APPLICATION

This application claims the benefit of priority to an Iran patent application having Iran Patent Application Serial Number 139350140003009224, filed on Nov. 23, 2014 and issued as Iran Patent Number 85624 on May 9, 2015, the entire content of which is incorporated herein by reference.

### TECHNICAL FIELD

The present application relates generally to fisheries and environmental science chemistry and, more particularly, to a method for cleaning aquarium water using modified chitosan, without filtration.

### BACKGROUND

Control of water quality in both freshwater and marine aquariums is usually conducted by using filtration systems. These filtration systems include mechanical filtration devices for organic material and components for biological conversion of ammonia to nitrate by immobilized nitrifying bacteria.

With the booming interest in the aquarium hobby and, consequently, the introduction of new exotic ornamental fish species, higher demands are set with regard to the water quality in aquariums. Much of the recent literature in this field stresses the need for nitrate removal for several reasons. Some ornamental fish species are unable to propagate or grow in water containing high nitrate levels (e.g. soft-water fish species such as discus, marine fish species). High nitrate levels in aquariums stimulate undesired algal growth on the walls of the aquaria (fouling). Some of the known systems for nitrate removal from aquariums control nitrate concentrations by periodical dilution of the aquarium water with clean water. Other such systems remove nitrate from aquariums by bio-filtration. Bio-filtration is based on the principle of creating conditions which stimulate growth of denitrifying bacteria that reduce nitrate to nitrogen gas. Conditions for the growth of these denitrifying bacteria include absence of oxygen, and presence of a degradable organic carbon source to serve as feed for denitrifiers.

Unlike filters used for ammonia removal, the performance of denitrifying filters is often erratic and their successful use largely depends on the skills and experience of the operator. Specifically, it is often difficult to pass water to be modified through an anoxic, denitrifying zone without causing oxygen enrichment of this zone.

Considering the existing need for nitrate removal from aquariums and, furthermore, problems encountered with the commercially-available filters for nitrate removal, a need exists for denitrifying water without applying filters such as electrical filters installed outside the aquarium or on the aquarium floor.

### SUMMARY

In one general aspect, the instant application describes a method for cleaning water. The method includes adding chitosan into an solution of acetic acid; adding thiosemicarbazide into the solution having the added chitosan; and stirring the solution having the added chitosan and thiosemicarbazide. The stirred solution is then neutralized with aqueous sodium hydroxide to form precipitates. The precipitates are then filtered and washed a plurality of times with deionized water and ethanol. The washed precipitates are then dried under vacuum to produce a modified chitosan. The modified chitosan is added to the water to remove chemicals from the water.

The above general aspect may include one or more of the following features. Modification of chitosan may include using formaldehyde as coupling link reagent. Adding the modified chitosan to the water may include placing the modified chitosan in a reticulated chamber in a container containing the water. The chemicals removed from water by the modified chitosan may include nitrate, ammonia, solids, minerals, heavy metals, paints, amino acids, proteins, oil, grease, or a combination thereof. Removing the chemicals by the modified chitosan may include surrounding the chemicals by the modified chitosan molecules and turning the surrounded chemicals into clots. The chitosan can be obtained by treating shrimp or other crustacean shells with alkali sodium hydroxide. The used modified chitosan can be cleaned by acid washing and reused for cleaning water.

### BRIEF DESCRIPTION OF THE DRAWINGS

Features of the subject technology are set forth in the appended claims. However, for purpose of explanation, several implementations of the subject technology are set forth in the following FIGURE.

FIG. 1 illustrates an example of a process of cleaning water using chitosan, according to one implementation.

### DETAILED DESCRIPTION

In the following detailed description, specific details are set forth by way of examples in order to provide a thorough understanding of the relevant teachings. However, it should be apparent to those skilled in the art that the present teachings may be practiced without such details. In other instances, well known methods, procedures, and components have been described at a relatively high-level, without detail, in order to avoid unnecessarily obscuring aspects of the present teachings.

Aquarium water pollution by nitrates, ammonia and organic compounds containing fecal material of the fish and the remainder of fish feed, may cause various problems for aquatic health and well-being. Therefore, it is essential to reduce the presence of chemicals in the aquatic environment.

The chemical filtration material used such as, for example, activated charcoal, pollute the aquatic environment and are harmful to the fish health. However, the current disclosure describes reducing nitrate accumulation in the water while preventing introduction of chemicals into the water that may cause further water pollution and stress the fish.

Known water filtration techniques include using various types of filters such as, for example, ceramic filters, bio-balls, silica pore expansion (siporex), substrates, zeolite (e.g., enzymite), activated charcoal, resin, etc. For example, siporex is a light weight concrete block with higher strength than ordinary concrete. Due to high density and porous structure, siporex can be used to grow useful bacteria in aquarium water for water filtration purpose. Ceramic filters, due to their microscopic pores, provide a suitable environment for nitrite eating bacteria to live and reproduce. The bacteria can develop colonies inside the ceramic. Bio-balls provide environments for production of certain species of useful bacteria for aquarium water. Water passes through holes in a bio-ball and the resulted water turbulence provides a suitable environment for useful bacteria growth and reproduction. Bio-balls are made of a type of plastic called acrylonitrile butadiene styrene (ABS) and may have various shapes and sizes.

Substrates are made of heated quartz and provide a rough surface for the useful bacteria to inhabit. Activated charcoal is produced by activating the ordinary charcoal by silver (Ag). The silver in the activated charcoal has a disinfecting effect. The excess amount of silver in the activated charcoal may pollute the water. In addition, the activated charcoal may be crushed and mixed with the water which is hard to clean and may also harm the living organisms and fish.

Zeolite is used for removing ammonia from fresh water. Ammonia is found in the fish waste and is harmful to the fish. However, zeolite does not remove nitrite from water or ammonia from salty water. Resins which are similar to insect eggs, reduce water hardness and increase water acidity.

The known filtration techniques, as described above, have various shortcomings and problems. The present disclosure aims at providing a low cost and effective water cleaning method using modified chitosan an environmental friendly material.

Chitosan is a linear polysaccharide composed of randomly distributed β-(1-4)-linked D-glucosamine (deacetylated unit) and N-acetyl-D-glucosamine (acetylated unit). It is made by treating shrimp and other crustacean shells with the alkali sodium hydroxide. Chitosan is produced commercially by deacetylation of chitin, which is the structural element in the exoskeleton of crustaceans (such as crabs and shrimp) and cell walls of fungi. The main source of chitosan is crustacean shells remaining as waste from food industries. The shells are periodically mixed with acid and alkali material to produce chitin. The chitin is then deacetylated using sodium hydroxide in excess as a reagent and water as a solvent.

Chitosan, due to its cationic characteristics and chain structure of its molecules, has a high adsorption capacity. Chitosan molecules can surround suspended solids; minerals; heavy metals such as zinc, chromium, arsenic, titanium dioxide, and phosphorus; paints and coloring substances; amino acids; proteins; oils and grease from water. The material surrounded by chitosan molecules turn into clots that can be easily removed from the water.

The use of chitosan can improve water quality and reduce smell and taste of the water. Water filtration industries use chitosan as a bacteria growth environment such that the bacteria can reduce nitrate to nitrogen gas.

The disclosure describes using chitosan a material compatible with the natural environment through the removal of the organic and inorganic (such as nitrates) present in aquarium water. As disclosed herein, chitosan can be used as an adsorbent for cleaning water without applying any filtration equipment, such as electrical filters, filters installed outside the aquarium and filters installed on the aquarium floor. The structure of the chitosan is shown in formula 1.

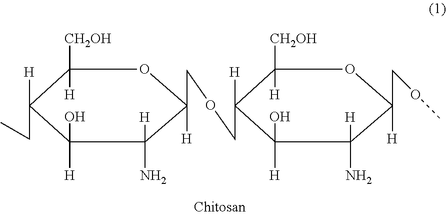

In one embodiment of the present disclosure, adsorption capacity of chitosan can be increased by modifying chitosan using an amino-thiourea functional group. The amino-thiourea modified chitosan has a selective adsorption capacity higher than the adsorption capacity of the unmodified chitosan, because the amino-thiourea modified chitosan is capable of hydrogen bonding and electrostatic interactions with nitrate ions. The amino-thiourea modification of chitosan can increase the adsorption capacity of the modified chitosan up to %30. As a result, the amino-thiourea modified chitosan can remove nitrate from water with higher efficiency compared to unmodified chitosan.

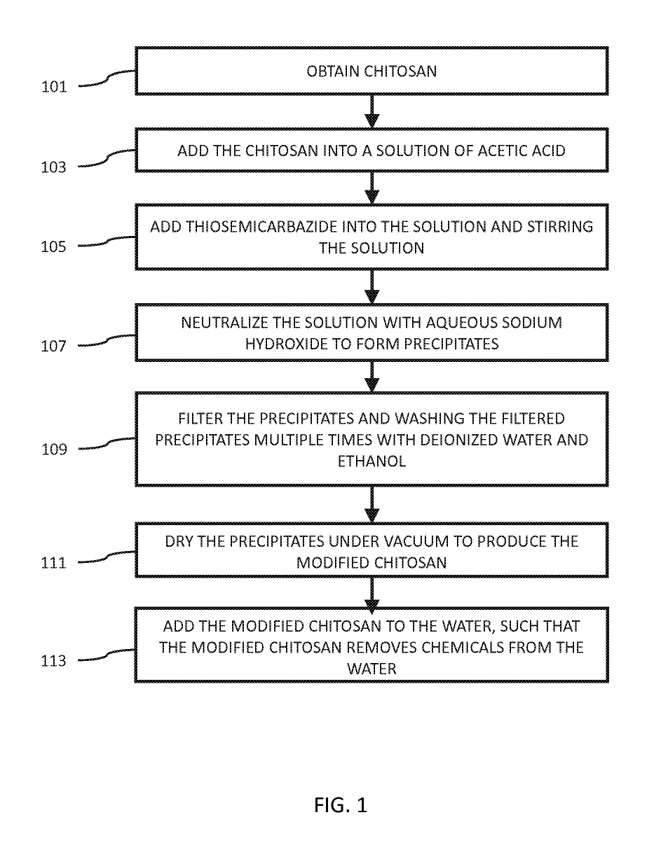

FIG. 1 illustrates an example of a process of cleaning water using chitosan, according to one implementation. Modification of chitosan can be performed with thiosemicarbazide (TS). The modification can be accomplished by using formaldehyde as coupling link reagent. At block 101 of FIG. 1, chitosan is obtained and at block 103, chitosan can be added into a solution of acetic acid. Subsequently, at block 105, the TS can be added to the solution and stirred. The obtained product can be neutralized, at block 107, with aqueous sodium hydroxide (NaOH) to form precipitates. At block 109, the precipitates can be filtrated and washed with deionized water and ethanol several times, and then, at block 111, the solution can be dried under vacuum to produce modified chitosan. The modified chitosan can be in the form of a pale powder. At block 113, the modified chitosan can be added to the water to remove chemicals from the water.

In order to clean water in a container (e.g., in an aquarium), the modified chitosan can be placed in a reticulated chamber in the aquarium. In an experimental trial, the test chamber kept for 36 hours at room temperature. At the end of the experiment, the water sample of the aquarium was filtrated through a 0.10 μm membrane filter and concentration of nitrate ions in the filtrate was analyzed with spectrophotometric method. The nitrate ion removal by adsorption of the sample was calculated by mass balance as of the concentration of nitrate ions before and after adsorption. The used polluted chitosan can be cleaned by acid washing, and can be reused for further cleaning of water, for example, by removing nitrate from water. Using the disclosed method, up to 96 percent of nitrate ions can be removed from water.

Using modified chitosan in water cleaning can have various advantages such as, for example, high capability of removing nitrite, disinfecting the water, removal of ammonia a dangerous substance with a foul smell, improving water clarity, increasing amount of oxygen solved in water, reducing stress in fish due to external substances, improving fish appetite, preventing growth of algae in water, removing color and foul smell from water, increasing growth and reproduction rate of the fish, increasing the oxidation reduction potential (ORP) of water, reducing need for changing water, etc.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. A method for cleaning water, the method comprising:
adding chitosan into an solution of acetic acid;
adding thiosemicarbazide into the solution having the added chitosan;
stirring the solution having the added chitosan and thiosemicarbazide;
neutralizing the stirred solution with aqueous sodium hydroxide to form precipitates;
filtering the precipitates and washing the filtered precipitates a plurality of times with deionized water and ethanol;
drying the washed precipitates under vacuum to produce a modified chitosan; and
adding the modified chitosan to the water to remove chemicals from the water.

2. The method of claim 1, wherein the modified chitosan has a selective adsorption capacity higher than adsorption capacity of the chitosan prior to modification.

3. The method of claim 1, wherein modifying the chitosan includes using formaldehyde as coupling link reagent.

4. The method of claim 1, wherein adding the modified chitosan to the water includes placing the modified chitosan in a reticulated chamber in a container containing the water.

5. The method of claim 1, wherein the chemicals include nitrate, ammonia, solids, minerals, heavy metals, paints, amino acids, proteins, oil, grease, or a combination thereof.

6. The method of claim 1, wherein the modified chitosan is configured to surround the chemicals and turn the surrounded chemicals into clots.

7. The method of claim 1, further comprising obtaining chitosan by treating shrimp or other crustacean shells with alkali sodium hydroxide.

8. The method of claim 1, wherein the modified chitosan used to remove the chemicals from the water is cleaned by acid washing and subsequently reused for cleaning water.
